(19) United States
(12) Patent Application Publication
(10) Pub. No.: US 2016/0055517 A1
(43) Pub. Date: Feb. 25, 2016

(54) SYSTEM AND METHOD FOR COUPON STORING AND ACCESS

(71) Applicant: Regina Jenkins, Suffolk, VA (US)

(72) Inventor: Regina Jenkins, Suffolk, VA (US)

(21) Appl. No.: 14/464,680

(22) Filed: Aug. 20, 2014

(51) Int. Cl. G06Q 30/02

(52) U.S. Cl. CPC G06Q 30/0237

(57) ABSTRACT

A system and method of coupon storage and access that integrates coupons from a plurality of sources so that they can all be sorted, accessed and used through a single electronic interface. The system and method of coupon storage and access is embodied on a coupon store and save mobile computer device that comprises a device housing with a display screen, a camera, and a keyboard on its front side. The device housing additionally includes on its sides a backlight manual switch, a first charging port, a second charging port, a locking switch, and a data entry port. Internally, the device housing includes a processor, non-volatile memory, a rechargeable battery, and a Wi-Fi receiver. In use, the coupon store and save device saves and catalogs coupons so that they can subsequently accessed by point of sale devices when it is desired to redeem the coupon.

### BACKGROUND OF THE INVENTION

1. Field of the Invention

This invention relates generally to remote storage and access systems and, more particularly, to an electronic device configured to scan, store and enable subsequent access of paper coupons.

2. Description of the Prior Art

The use of marketing coupons (or “coupons”), typically to be exchanged for a financial discount or rebate when purchasing a product or service, is well known. Coupons are commonly distributed through mail, coupon envelopes, magazines, newspapers, the Internet (social media, email newsletter), directly from the retailer, and mobile devices such as cell phones and are operative to enable retailers to offer a lower price only to certain consumers. While coupons are conventionally embodied as a physical ticket or document, in recent times, coupons have been more commonly availed through electronic mediums, thereby enhancing convenience for consumers and reducing distribution costs for marketers.

From the consumer standpoint, a problem which still exists is that as coupons are distributed in through more and more mediums, finding coupons has become more time consuming. Furthermore, once found, it is increasingly more difficult to store and subsequently produce coupons for use at the appropriate time. Thus, there remains a need for a system and method of coupon storage and access that enables printed coupons to be scanned and saved therein for subsequent retrieval and use. It would be helpful if such a system and method of coupon storage and cataloged identification information for each saved coupon to enable subsequent access through keyword searching. It would be additionally desirable for such a system and method of coupon storage and access to download and save coupons from Internet locations for subsequent retrieval and use. It would further be helpful if such a system and method of coupon storage and access employed a universal search engine that simultaneously searched internal memory for saved coupons and website content on the Internet when retrieving coupons.

The Applicant's invention described herein provides for a system and method of coupon storage and access, embodied in a coupon store and save device, that provides a mobile medium through which coupons can be located, saved, and used. The primary steps in Applicant's system and method of coupon storage and access are receiving coupons, cataloging coupons, and retrieving coupons. When in operation, the system and method of coupon storage and access enhances a user's ability to locate, save, and use coupons from print media and electronic media. As a result, many of the limitations imposed by prior art systems are removed.

### SUMMARY OF THE INVENTION

A system and method of coupon storage and access that integrates coupons from a plurality of sources so that they can all be sorted, accessed and used through a single electronic interface. The system and method of coupon storage and access is embodied on a coupon store and save mobile computer device that comprises a device housing with a display screen, a camera, and a keyboard on its front side. The device housing additionally includes on its sides a backlight manual switch, a first charging port, a second charging port, a locking switch, and a data entry port. Internally, the device housing includes a processor, non-volatile memory, a rechargeable battery, and a Wi-Fi receiver.

In use, the coupon store and save device saves and catalogs coupons input through the camera and that have been downloaded, enabling them to be retrieved along with online coupons through a universal search engine. Retrieve coupons can then be selected and displayed on the display screen to allow them to be accessed by point of sale devices so the user can receive the offered discount.

It is an object of this invention to provide a system and method of coupon storage and access that enables printed coupons to be scanned and saved therein for subsequent retrieval and use.

It is another object of this invention to provide a system and method of coupon storage that cataloged identification information for each saved coupon into a coupon data entry having descriptive metadata, enabling subsequent access through keyword searching.

It is yet another object of this invention to provide a system and method of coupon storage and access downloads and saves coupons from Internet locations for subsequent retrieval and use.

It is still another object of this invention to provide a system and method of coupon storage and access that employs a universal search engine that simultaneously searched internal memory for saved coupons and website content on the Internet when retrieving coupons.

These and other objects will be apparent to one of skill in the art.

### BRIEF DESCRIPTION OF THE DRAWINGS

FIG. 1 is a front elevational view of a coupon store and save device built in accordance with the present invention.

FIG. 2 shows the data flow for the various data inputs and the catalog and search functions for a system and method of coupon storage and access built in accordance with the present invention.

FIG. 3 shows the saved coupon entry process of a system and method of coupon storage and access in accordance with the present invention.

FIG. 4 shows the initial startup routine of a system and method of coupon storage and access in accordance with the present invention.

### DETAILED DESCRIPTION OF THE INVENTION

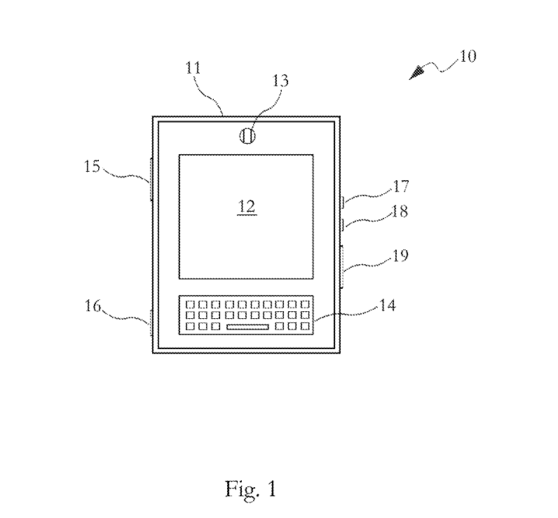

Referring now to the drawings and in particular FIG. 1, a system and method of coupon storage and access in accordance with the present invention is embodied on a mobile computer device defined as a coupon store and save device 10. In the preferred embodiment, the coupon store and save device 10 is defined by a device housing 11 with a display screen 12, an image scanner defined as a camera 13, a manual input interface define as a keyboard 14 as base components. The device housing 11, which is constructed as conventional mobile electronic computer device housings, additionally includes a plurality secondary components, defined as a backlight manual switch 15, a first charging port 16, a second charging port 17, a locking switch 18, and a data entry port 19. Internally, the device housing includes a processor, non-volatile memory, with the non-volatile memory containing instructions that enable the processor to perform general computing operations as well as the operational processes described herein, a rechargeable battery that supplies electricity to the base components, receives electricity from the first charging port 16 and second charging port 17, and a networking interface defined as a Wi-Fi receiver.

The display screen 12 is defined as a conventional graphical user interface screen. In one embodiment, the display screen is defined as a touch screen that enables it to additional receive manual user input. It is contemplated that the display screen 12 can reproduce all of the descriptive data of saved and online coupons that have been retrieved, including the bar code so as to allow it to be scanned for use at the point of sale.

The camera 13 defines in the preferred embodiment the image scanner of the coupon store and save device 10. In alternate embodiments, an alternate optical image scanner may be deployed on the front, back or as a slide out structure in said device housing 11. Furthermore, it is understood that an auxiliary, conventional optical image scanning device may be utilized by connecting it to the data entry port 19, defined in the preferred embodiment as a serial bus port.

The keyboard 14 defines the manual user interface of the coupon store and save device 10 in the illustrated embodiment. It is contemplated, however, that an alternate manual user interface may define a touch screen or an auxiliary, conventional manual input device connected to said data entry port 19.

The backlight manual switch 15 operates to receive manual input that turns on and off an integrated backlight system that illuminates the display screen 12 and the keyboard 14.

The first charging port 16 and second charging port 17 are each structured to receive a discrete serial plug that through which data and electricity can be transmitted. In one embodiment, the first charging port 16 defines a USB port and the second charging port 17 defines a Firewire port.

The locking switch 19 operates to receive manual input that locks and unlocks the user input components of the coupon store and save device 10.

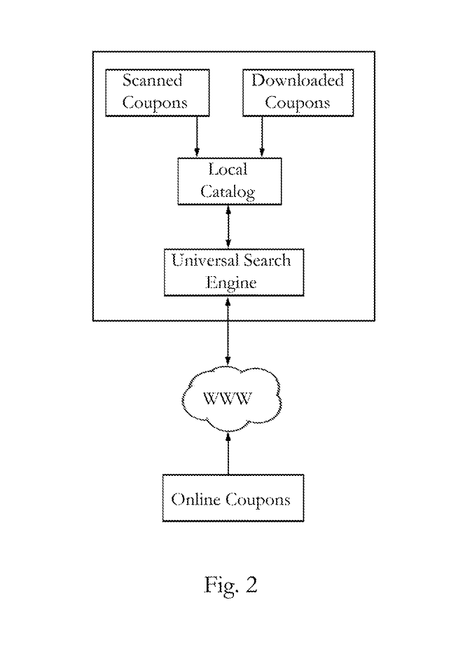

Referring now to FIG. 2, the system and method of coupon storage and access integrates coupons from a plurality of sources so that they can all be sorted and accessed through a single interface. Local coupons included downloaded and scanned coupons. In this regard, coupons can be scanned into a coupon store and save device built in accordance with the present invention through its image scanner and coupons can be downloaded into a coupon store and save device built in accordance with the present invention over the networking interface. Such local coupons (or “saved coupons”) are stored in the non-volatile memory of the coupon store and save device and coupon data extracted therefrom is stored in a relational database defining a local catalog.

In addition, online coupons may be accessed through the network interface. To allow a user to navigate saved coupons and online coupons together, a universal search engine operated by the processor of the coupon store and save device uses conventional character search functions to match and retrieve relevant words from the local catalog and in online coupon metadata in response to manually entered queries. In this regard, when a user types “coffee” into the universal search engine interface on the coupon store and save device, all saved coupons which include “coffee” and any online coupons containing the word “coffee” are retrieved and listed for the user to review. It is understood that such a query may include served coffee from coffee shops as well as retail coffee packages at grocery or convenience stores.

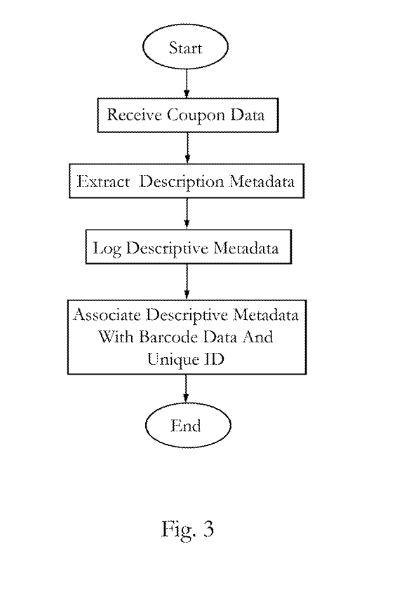

Referring now to FIG. 3, with respect to searching and retrieving saved coupons, the universal search engine is dependent on the extraction and indexing functions of the coupon store and save device as they are input. Whenever a coupon is to be stored by the coupon store and save device, data relating to that coupon must be input into the coupon store and save device. This data may be input through the optical scanner of the coupon store and save device or by downloading the data from a networked source. It is contemplated that the coupon data will include descriptive metadata and barcode data (or other universal identifier). The descriptive metadata, which includes merchant name, discounted product, discount offered, and expiration date, is then extracted and placed in the local catalog, where it is associated with barcode data and a local unique identifier in the relational database. As such, to search and retrieve saved coupons, the universal search engine merely has to character match in the local catalog, pull the local unique identifier of matches, and display the metadata associated with the pulled local unique identifiers.

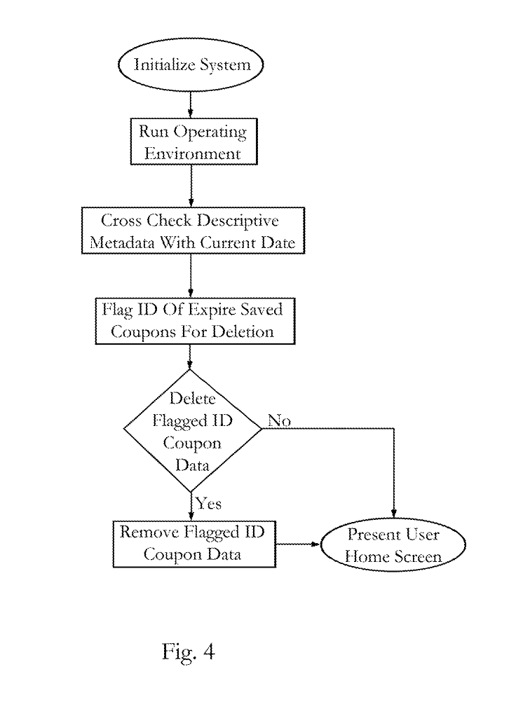

Referring now to FIG. 4, the system and method of coupon storage and access includes in its startup routine an automatic cleanup function that allows coupon data for expired coupons to be deleted from internal memory. Thus, whenever the coupon store and save device is turned on or restarted to cause it to initialize and start up its operating environment, it runs a cross check of the current date against the each expiration date stored in the local catalog and flags the local unique identifier of all coupon data entries in the database having an expiration date before the present date. The option is then provided on the display screen to delete all flagged coupon data entries having a flagged local unique identifier. If the user selects yes, the flagged coupon data entries with flagged ids are deleted and the user home screen comes up on the display screen. If the user selects no, and the user home screen comes up on the display screen and the coupon data entries with flagged ids remain on the internal memory. It is understood, however, that on subsequent startups, these same coupon data entries will again be flagged (possible along with new expired entries) and the user will again have the choice to delete them.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A coupon store and save device, comprising:
a device housing having a front surface, a left side surface, right side surface, and a back surface;
a display screen disposed on said front surface of the device housing;
an image scanner disposed on said device housing;
a manual input interface disposed on said front surface of the device housing;
a processor, non-volatile memory, a rechargeable battery and a networking interface disposed inside said device housing, wherein said rechargeable battery is operative to supply electricity to the components on and in said device housing and said non-volatile memory contains instructions that enable the processor to perform the following functions;
extract coupon data, wherein the step of extracting includes retrieving descriptive metadata and barcode data from a source coupon
log descriptive metadata, wherein the step of logging includes inputting extracted descriptive metadata into a coupon data entry in a relational database stored on said non-volatile memory; and
associate coupon data, wherein the step of associating includes linking the descriptive metadata in a coupon data entry with the barcode data it was extracted with and a local unique identifier.

2. The coupon store and save device of claim 1, wherein said non-volatile memory contains instructions that enable the processor to additionally run an automatic cleanup function on startup.

3. The coupon store and save device of claim 1, additionally comprising a backlight manual switch disposed on at least one of said left side surface and said right side surface, wherein said backlight manual switch is operative to illuminate at least one of the display screen and the manual input interface.

4. The coupon store and save device of claim 1, additionally comprising a first discrete charging port and a second discrete charging port, each disposed on at least one of said left side surface and said right side surface, wherein at least one the first charging port and second charging port are each electrically connected to said rechargeable battery, thereby enabling said rechargeable battery to receives electricity therefrom.

5. The coupon store and save device of claim 4, wherein the first charging port defines a USB port and the second charging port defines a Firewire port.

6. The coupon store and save device of claim 1, additionally comprising a locking switch disposed on at least one of said left side surface and said right side surface, wherein said locking switch is operative to receive manual input and cause at least one of the display screen and the manual input interface lock and unlock.

7. The coupon store and save device of claim 1, additionally comprising a data entry port disposed on at least one of said left side surface and said right side surface, wherein said data entry port is enables at least one of an auxiliary, conventional optical image scanning device and an auxiliary, conventional manual input device to be communicatively connected to said coupon store and save device.

8. The coupon store and save device of claim 1, wherein the image scanner is a camera.

9. The coupon store and save device of claim 1, wherein the image scanner is on the front surface.

10. The coupon store and save device of claim 1, wherein the image scanner is on the back surface.

11. The coupon store and save device of claim 1, wherein the networking interface is a Wi-Fi receiver.

11. The coupon store and save device of claim 1, wherein the manual input interface is a physical keyboard.

12. The coupon store and save device of claim 1, wherein the manual user input interface and the display screen are embodied as a touch screen.
